(19) United States
(12) Patent Application Publication
(10) Pub. No.: US 2025/0285299 A1
(43) Pub. Date: Sep. 11, 2025

(54) METHOD AND APPARATUS FOR EXTRACTING UNAMBIGUOUS UAV (E.G. DRONE) SIGNATURE USING HIGH-SPEED CAMERA

(71) Applicants: NATIONAL RESEARCH COUNCIL OF CANADA, Ottawa (CA); HIS MAJESTY THE KING IN RIGHT OF CANADA, AS REPRESENTED BY THE MINISTER OF NATIONAL DEFENCE, Ottawa (CA)

(72) Inventors: Frank Billy Djupkep Dizeu, Gatineau (CA); Michel Picard, Ottawa (CA); Marc-Antoine Drouin, Gatineau (CA); Guillaume Gagne, Levis (CA)

(21) Appl. No.: 18/859,943

(22) PCT Filed: Apr. 25, 2023
(86) PCT No.: PCT/IB2023/054223

§ 371 Date: Oct. 24, 2024

Related U.S. Application Data
(60) Provisional application No. 63/460,247, filed on Apr. 18, 2023.

(30) Foreign Application Priority Data
Apr. 26, 2022 (CA) 3157750

(51) Int. Cl. G06T 7/254; G06V 20/40

(52) U.S. Cl. CPC G06T 7/254; G06V 20/44

(57) ABSTRACT

Systems and methods for drone detection via the extraction of related propeller signature using a high performance camera.

### FIELD OF THE INVENTION

This invention relates to the detection of drones and more specifically to a Method and Apparatus for Extracting Unambiguous Drone Signature Using High-performance Camera such as a high speed camera or a non-neuromorphic event based camera.

### ABSTRACT

Systems and methods for drone detection via the extraction of related propellor signature using a high performance camera.

### BACKGROUND

Drones (interchangeably unmanned aerial vehicles or UAVs) are aircraft that can be steered non-autonomously by a ground pilot through radiofrequency exchanges, or autonomously by closed loop computer systems. Over the past decade, due to the emergence of companies commercializing different types of affordable drones (multi-copters) with increasing performance, there has been an exponential growth in the popularity of drones for recreational purposes and commercial activities, including aerial videos shooting, surveying, cartography, monitoring of public space (for example to enforce social distancing during the COVID-19 pandemic), search and rescue, delivery of goods and medicine, etc. Experts agree on continued growth in the size of the drone market and forecast five hundred billion dollars in revenue by 2028. This will represent tens of millions of drone owners around the world. Unfortunately, this growing use of drones (in particular for recreational activities) raises concerns about privacy, but also security of sensitive areas such as airports, prisons, and industrial and military facilities. Although in many countries bills are passed and legislation is updated to regulate drone activities, it is very likely that an untrained pilot does not know the legislation, and a motivated criminal simply does not care. Illegal/criminal drone activities recently reported include the crash of a drone in front of the white house lawn in January 2015, a collision between a commercial airplane and a drone at the Jean Lesage international airport at Quebec city, Canada in 2017, a mysterious presence of several drones for several days around a nuclear power plant in France, the use of drones to bomb a Ukrainian army weapons warehouse, an attempt to use drones to drop items at prisons, for drug smuggling, for illegal phones traffic, etc.

In the coming years, drones will become a predominant source of intentional and unintentional threats. Therefore, counter-measures are required against illegal and criminal drone activities; one of them is the development of drone detection systems, which is increasingly gaining the attention of the research community, both in academia and in industry.

It is known that various modalities, including radar, audio, radio frequency (RF), camera, have been proposed for detection, tracking, classification for eventual neutralization of drones. Multimodal approaches combining two or more of these individual modalities have also been proposed. Moreover, there is a strong trend towards drone detection systems using machine/deep learning.

The basic principle in acoustic-based drone detection systems is the recognition of the audio signature of the spinning propellers in the ambient noise recorded with a microphone. Feasibility of acoustic-based drone detection using hidden Markov model has been demonstrated. Correlation techniques have also been used, where pre-recorded audio fingerprints of drones are identified in the recorded ambient noise. This requires an audio fingerprint for each existing drone model. Machine/deep learning classifiers are also reported and rely on different architectures, including PIL (plotted image machine learning) and KNN (k-nearest neighbors), multi class SVM (support vector machines), and CNN (convolutional neural network). One aspect of acoustic-based drone detection systems is their ability to operate day and night. They can alert to the presence of nearby drones, but cannot be used for tracking purposes. Moreover, they are not robust to intentional alteration or camouflage of the drone's acoustic fingerprint, and to noise resulting, for example, from the proximity of an urban area.

Traditional radar sensors deliver information about the distance, the size (radar cross section) and the speed of objects in an active manner, that is, by sending electromagnetic pulses in a given direction in space and analyzing the electromagnetic energy reflected from potential target objects. One strength of radar systems is their ability to perform long range detection, even under unfavorable light and weather conditions. However conventional radar systems are not optimized for detecting small drones moving slowly and flying at low altitude. This led to the development of millimeter wave frequencies systems which can provide better radar cross section resolution depending on the material constituting the drone.

A survey on radar-based drone detection reveals three groups of methods. Methods of the first group aim to understand the radar signatures of drones produced in the micro-Doppler domain and characterize the sensed radar cross section in order to set suitable thresholds and detection ranges. The second group includes methods using physics-based criteria or neural networks for drone detection and classification. The last group is formed by passive radar systems which are less expensive than active radar systems.

Radio frequency (RF)-based systems detect drones by monitoring the radio frequency data exchange between these drones and their controllers. They are transportable and can achieve long-range detection and tracking, making them the most popular anti-drone systems on the market. They can ultimately be designed to locate the drone pilots. Different features have been considered for training a machine learning architecture in RF-based drone detection systems. RF signatures of the body shifting of drone caused by the spinning propellers and that of the body vibration due to environmental factors (wind for example) may be exploited. Raw RF signals may be converted into frames in the wavelet domain and used as features for the training. Hierarchical learning may be used; the repetitive synchronization packets in video traffic between drones and controllers are used as features to train a random forest model. Compared to radar systems, radio frequency systems are energy efficient since they use passive RF sensors. Compared to acoustic systems, they are more robust to environment noise due to the strength of RF signals received. The problem with this drone detection modality is that they require radio frequency exchange between the drone and its controller; conceptually, they cannot detect drones pre-programmed for autonomous flight.

Camera-based drone detection systems include vision-based systems (RGB cameras), thermal-based systems (infrared cameras), and event-based systems (neuromorphic cameras). Vision-based drone detection is being attracting attention due to its good balance between price and detection capability, and also because it can provide additional visual information (drone model and color, dimensions, payload) for easy human interpretation. Unlike radar-based systems, with which they share the need of a line of sight, vision based systems are passive. Unlike RF-based systems, they can detect autonomous drones. Most vision-based drone detection systems rely on features extraction or deep learning. Features-based approaches use morphological operators/descriptors to extract relevant features which are then used by a classifier. Deep learning approaches exploit various neural network architectures including CNN, Faster region based CNN, YOLO (You only look once), etc. Motion of both drones and camera has also been addressed. Frame difference may be used to detect moving objects (flying entities) which are then classified as drones or not. Regression may be used for motion stabilization followed by CNN classification. Moving cameras are used for drone detection in the context of drone cooperation, multi-drone autonomous navigation and collision avoidance. Accuracy of vision-based drone detection methods typically decreases with the contrast between the drone and background. It is particularly the case for long range detection where the drone is represented by few pixels and is similar in appearance, shape and size to birds. It is known to use a multicamera strategy (one steady camera with a large field of view is used to detect intruders, one moving camera with a small field of view follows each intruder to provide high resolution tracking result to the classifier), or deep learning.

RGB-D systems, based on either time of flight or stereo vision, have also been proposed for segmenting drones from background using 3D data (depth). Vision-based systems perform poorly in limited visibility conditions (night, dust, cloud, rain, snow or fog). For such scenarios, thermal cameras can be considered. However, it is very likely that the thermal signature of the drone is degraded by its constituting materials (plastic, carbon fiber), as well as by the thermal shielding of its electric motors. Moreover, for similar specifications, thermal cameras are more expensive than RGB cameras. Systems utilizing near infrared or short wave infrared cameras for drone detection (at night) have also been contemplated. Other devices that seem promising are neuromorphic cameras which captured the rapid changes in intensity, mainly related to motion, occurring in their field of views. In a recent paper, these cameras were used to detect drones by the frequency signature of their propellers. Unfortunately, neuromorphic cameras have, at the moment, a small spatial resolution.

Observing that no drone detection modality is perfect, some authors have proposed multimodal approaches to take advantage of the strengths and reduce the weaknesses of the individual modalities involved. Some multimodal drone detection systems reported in literature include the association of radar and audio sensors, a system constituted by a camera array with audio recording, the association of infrared and RGB cameras, a system combining a radar, a microphone array, and a RGB camera, and a system combining LIDAR, cameras (RGB and infrared).

From a kinematic point of view, flying entities are characterized by their moving speed which allows them to move from one point to another, and their acceleration which allows them to modify their moving direction and speed. Almost all flying entities share the same range of moving speed and acceleration (e.g., we can find birds and drones moving at 3 m/s with a linear trajectory), making it unreliable to rely on these kinematic parameters to differentiate them. Known camera-based methods rely on appearance to perform detection. The current state of the art includes acoustic-based, radar-based, radio frequency-based, and camera-based drone detection methods. Multimodal approaches combining two or more of these individual methods also exists. It is also known to augment appearance based camera detection with machine/deep learning.

What is needed is a reliable way to differentiate drones from other objects to buttress the qualification based mode of regulation and to allow security at sensitive locations.

### SUMMARY

According to one aspect herein described in detail there is a method of detecting a drone having a propeller with a distinct propellor rotation speed comprising:
imaging a plurality of images of a scene with a high-performance camera,
detecting in said images, for at least one pixel of said camera, a fingerprint characteristic that corresponds to said distinct propeller rotation speed.

Variants according to this aspect are: The method wherein said fingerprint is a series of integer multiples of a base rotation speed; The method wherein said detection is performed by a peak detection fitting algorithm; The method of claim 3 wherein a highest peak of the fingerprint is used in determining the rotation speed; The method further including the step of tracking any motion of said drone across said plurality of images; The method wherein detection comprises static background subtraction; The method wherein detection comprises a voting consensus to reconcile pixels of various propellors and drone body; The method wherein the high-performance camera is a high-speed camera; The method wherein the high-performance camera is a non-neuromorphic event-based camera.

According to one other aspect herein described in detail there is an apparatus for detecting a drone having a propeller with a distinct propellor rotation speed comprising:
a high-performance camera for imaging a plurality of images of a scene, and
a detector for detecting in said images, for at least one pixel of said camera, a fingerprint characteristic that corresponds to said distinct propeller rotation speed.

Variants according to this aspect are: The apparatus wherein said detector performs a peak detection fitting algorithm on the images; The apparatus 1 wherein the detector uses a highest peak of the fingerprint in determining the rotation speed; The apparatus wherein the detector further tracks any motion of said drone across said plurality of images; The apparatus wherein the detector performs static background subtraction; The apparatus wherein the detector uses a voting consensus to reconcile pixels of various propellors and drone body; The apparatus wherein the high-performance camera is a high-speed camera; The apparatus wherein the high-performance camera is a non-neuromorphic event-based camera.

### BRIEF DESCRIPTION OF THE DRAWINGS

FIG. 1 is a collection of pertinent experimental datum for the case of two blade propellors.

FIG. 2 is a collection of pertinent experimental datum for the case of four blade propellors.

FIG. 3 is an overview of processing steps according to an aspect of the invention.

FIG. 4 is an overview of drone tracking.

FIG. 5 is an example of apparatus according to an aspect of the invention and video setup according to an aspect of the invention.

FIG. 6 is a series of examples of experimental targets and corresponding video frames.

The drawings have not necessarily been drawn to scale. Similarly, some components and/or operations can be separated into different blocks or combined into a single block for the purposes of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Systems and methods for aerial unmanned vehicle (for example, drone) detection are described herein. While the disclosure uses the term “drone,” one of ordinary skill in the art would understand that the discussion would apply to other similar unmanned vehicles. Various implementations discussed below address different aspects of the infrastructure needed for detecting drones

In the following description, for the purposes of explanation, numerous specific details are set forth in order to provide a thorough understanding of implementations of the present technology. It will be apparent, however, to one skilled in the art that implementations of the present technology can be practiced without some of these specific details.

The techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in some implementations,” “according to some implementations,” “in the implementations shown,” “in other implementations,” and the like generally mean the particular feature, structure, or characteristic following the phrase is included in at least one implementation of the present technology, and can be included in more than one implementation. In addition, such phrases do not necessarily refer to the same implementations or different implementations.

Multi-copters (drones) are, compared to other objects, characterized by their propeller rotation speed. Therefore, for at least three reasons, it can be very appealing to rely on the propeller rotation speed to differentiate drones from other flying entities. First, the propeller rotation speed has a lower bound different from zero; this means that even when the drone is hovering (moving speed is equal zero), the propeller rotation speed is not null. Second, high speed cameras can be used to capture the fast propeller rotation. By high speed camera, it is meant a camera with a frame rate sufficiently high to capture the propeller rotation in the sense of the sampling theory. Third, the propeller rotation speed can be determined from a high frame rate video capturing the blades in rotation. In this paper, we use the propeller rotation speed as the key physical parameter on which to rely to unambiguously distinguish drones from other flying entities. The basic idea consists in using discrete Fourier transform to determine the propellers rotation speed from high frame rate videos, and extracting the propeller induced drone signature as an unambiguous quantitative camera-based drone signature.

The proposed algorithm proceeds as follows: a steady high speed camera observes the sky and flying entities are detected. These entities are continuously tracked over time and tracking results are stacked to build a stabilized high frame rate video ending at the current frame; discrete Fourier transform, performed pixel per pixel over the entire video sequence, is used to extract the propeller induced drone signature which confirm each flying entity as being a drone or not.

According to some aspects of the invention, a camera can is used to measure propeller rotation speed. Further, a unique propeller fingerprint is related to the propeller rotation speed, and can be determined from the camera video.

Considering one aspect of the present invention, a target propeller having Nb blades and performing V_{P} rotation per minute (rpm). Also, according to the present invention, an observing camera with frame rate fc capturing the rotating propeller in a video {I(p, tₘ)}ₚ₌₁^{p=n}^{ₚ}, m=1, 2, . . . , n_{f} having n_{f} frames and nₚ pixels per frame. I(p, tₘ) is the intensity at pixel p=1, 2, . . . , np in the frame m=1, 2, . . . , n_{f} which is captured at time tₘ=(m−1)/f_{c}. The discrete temporal intensity signal is extracted at pixel p as {I(p, tm)} where (m=n_{f}, m=1). In recorded video, if pixel p belongs to an area covered by a blade in rotation, discrete Fourier transform (DFT) of intensity signal can be used to determine the propeller rotation speed VP provided that the Shannon-Nyquist sampling theorem is satisfied, i.e., for:

$${f}_{c} > 2 {N}_{b} {V}_{P} \qquad ( 1 )$$

the magnitude of the DFT of intensity signal will show a peak at the fundamental frequency given by

$${f}_{0} = {N}_{b} {V}_{P} \qquad ( 2 )$$

Peaks will also be present at certain harmonic frequencies fi defined as follows:

$${f}_{i} = {if}_{0} \qquad ( 3 )$$

where i, the harmonic order, is a positive integer.

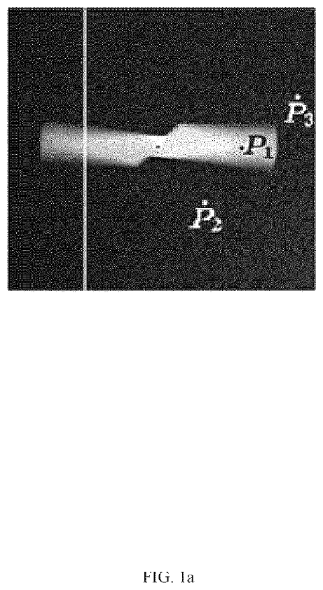

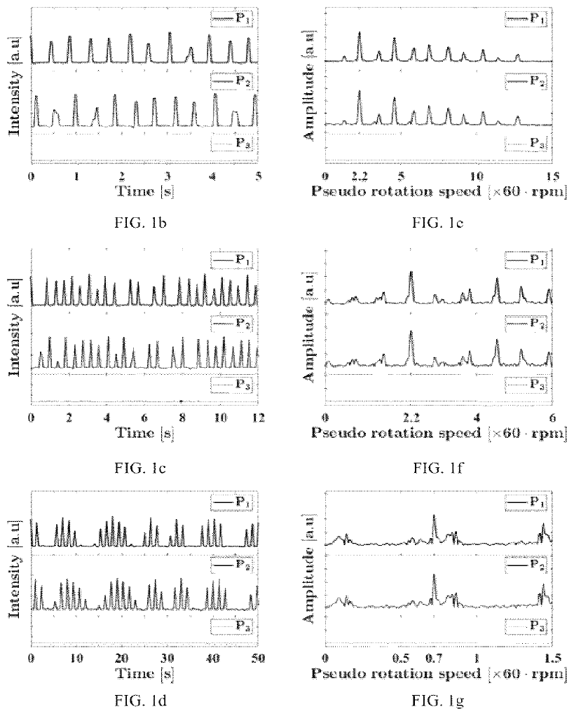

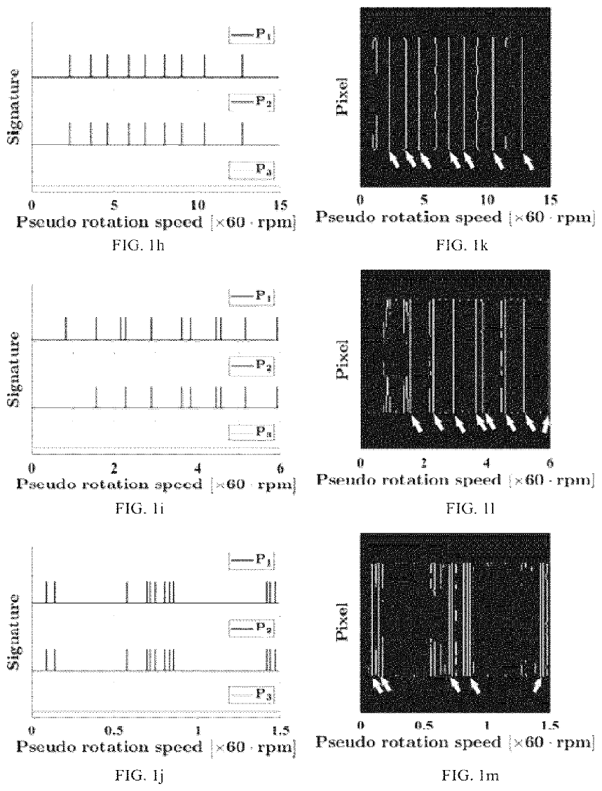

Considering a propeller made of two blades as illustrated in FIG. 1a and having a rotation speed of 66 rpm. Pixels p1 and p2 belong to the region covered by the blades during their motion, whereas pixel p3 belongs to the region not covered by the blades. The following camera frame rates are successively considered: 30 Hz, 12 Hz and 3 Hz. Only the first two camera frame rates satisfy the Shannon-Nyquist condition (EQ1).

FIG. 1b-d show intensity signals extracted at pixels p1, p2 and p3 for frame rates 30 Hz, 12 Hz and 3 Hz respectively. In all cases, signals have the same number of samples; this result in a longer acquisition time as the frame rate decreases. The corresponding DFT magnitudes are shown in FIG. 1e-g.

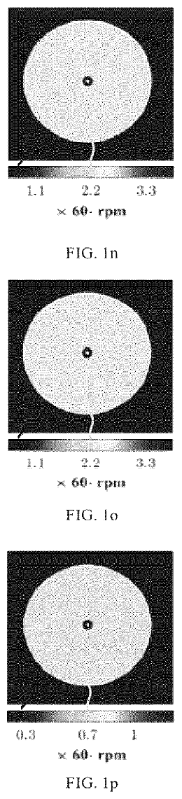

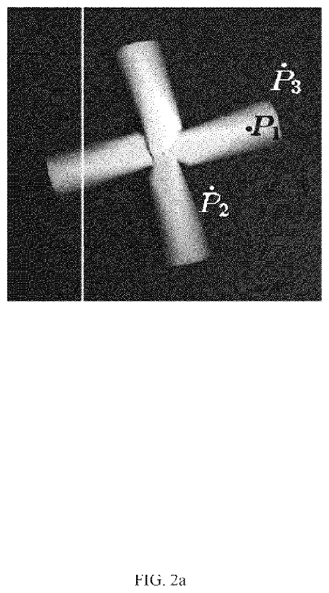

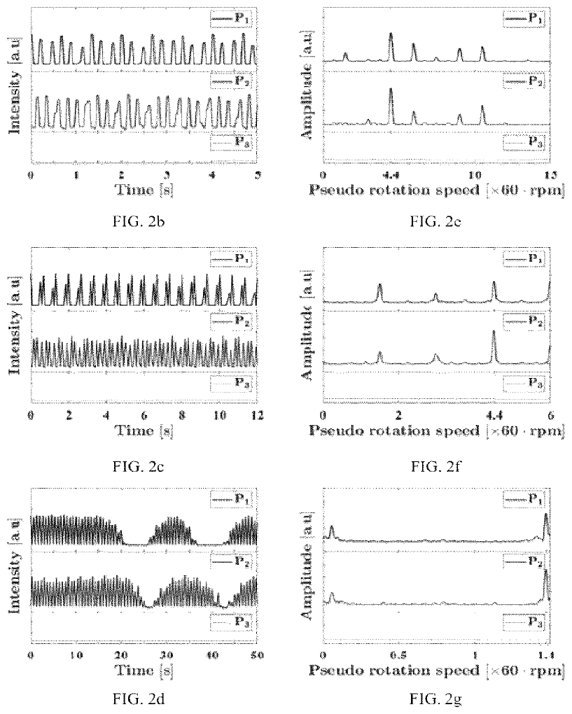

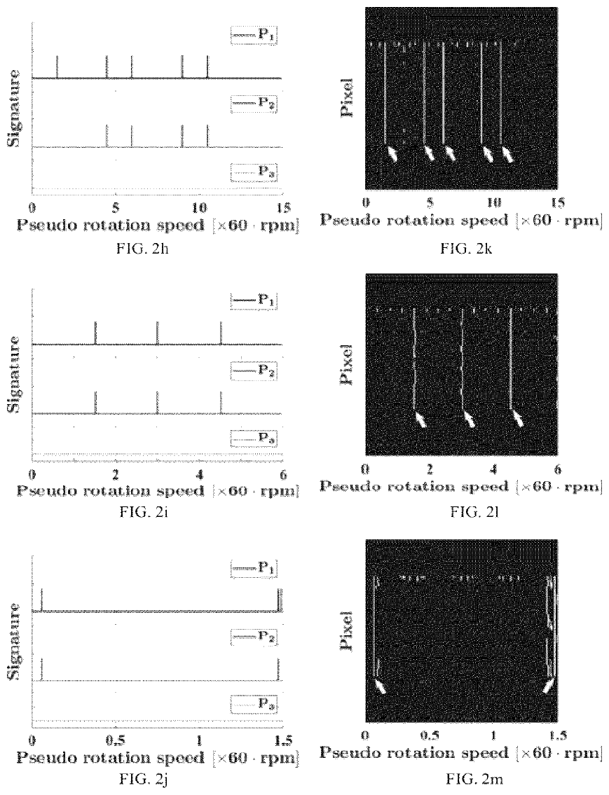

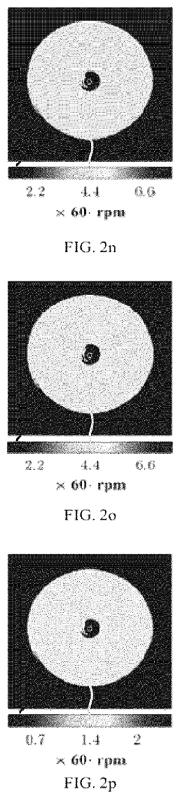

From the figure, the frequency axis is equated to the pseudo rotation speed \tilde{V} P axis as this axis is related to the propeller rotation speed. When the Shannon-Nyquist condition (EQ1) is satisfied, the pseudo rotation speed \tilde{V} P is proportional to the rotation speed V_{P} (\tilde{V} P=NbV_{P}). The fundamental frequency 2.2 Hz (\tilde{V} p=132 rpm) is obtained as the position of the highest peak for frame rates 30 Hz and 12 Hz. This is used to compute the rotation speed: (EQ2) yields V p=66 rpm. For the frame rate 3 Hz, it is not possible to determine Vp because the Shannon-Nyquist is not satisfied. However, regardless of the frame rate, a great similarity exists between magnitude spectra corresponding to pixels p1 and p2 which belong to the region covered by the blades. This is confirmed in FIG. 1h-j which show the position of the highest peaks in FIG. 1e-g. This set of peak positions, identical for all pixels covered by the blades in motion, forms a unique propeller fingerprint. We can confirm this by extracting the peak positions in the DFT magnitudes for all pixels along the yellow line in FIG. 1a. The results are shown in FIG. 1k-m for the considered frame rates. Each row in FIG. 1k-m indicates the peak positions obtained for a pixel on the yellow line in FIG. 1a. It is confirmed that pixels covered by the blades have most of their main peaks at the same positions (same pseudo rotation speed) which are the vertical lines indicated by the yellow arrows in FIG. 1k-m. DFT magnitudes for pixels not covered by the blades does not show any peak (black areas on the top and bottom in FIG. 1k-m). These qualitative analysis lead to three conclusions: (1) It is possible to retrieve the unique propeller fingerprint, closely related to the propeller rotation speed, by computing the DFT magnitude of intensity signals obtained by capturing the propeller rotation using a camera with a given frame rate. (2) A high sampling rate is preferable to reduce the data acquisition time. (3) If the frame rate of the camera satisfies the Shannon-Nyquist criterion, the propeller rotation speed can also be determined. Quantitatively, we can choose the position of the highest peak to represent the propeller fingerprint. The result is shown in FIG. 1n-p for frame rates 30 Hz, 12 Hz and 3 Hz respectively. Therefore, in this case study, the propeller fingerprint is quantitatively represented by the following pseudo rotation speed: 132 rpm for frame rates 30 Hz and 12 Hz, and 42 rpm for frame rate 3 Hz. A similar analysis performed on a four-blades propeller leads to the same conclusions (see FIG. 2).

According to another aspect of the invention, drones (multi-copters) form a unique class of flying entities characterized by a unique range of propeller rotation speeds with a lower bound of hundreds of rpm. We rely on the pseudo propeller rotation speed V P obtained using DFT to determine the unique fingerprint of each propeller of a drone. Together, these individual propeller fingerprints define the propellers induced drone signature (PIDS), an unambiguous camera-based drone signature. The PIDS discussed in this section is derived in three steps using a high frame rate video sequence. These steps are the static background subtraction, the peaks extraction and the voting consensus. At each step, criteria are used to classify pixels as belonging or not to a drone propeller. Thus, the number of pixels of interest decreases as one advances in the processing. The obtained PIDS represents the pixels most likely to belong to a propeller, or to be impacted by the rotation of the blades. According to this aspect, static background subtraction approach is used to extract the PIDS. The effectiveness of this simple approach demonstrates that the PIDS can easily be incorporated into appearance-based drone detection methods that may already include a more sophisticated background subtraction. The pseudo intensity is

$$\tilde{I} ( p , {t}_{m} ) = I ( p , {t}_{m} ) - \overline{I} ( p , {t}_{m} ) \qquad ( 4 )$$

where {Ī(p,tₘ)}ₘ₌₁^{m=n}^{_{f}} is the moving average of signal {I(p,tₘ)}ₘ₌₁^{m=n}^{_{f}}. The static background is formed by the pixels whose pseudo intensity does not significantly change throughout the video sequence. Note that Equation 4 is applicable to the algorithms described herein below. However, another high-performance camera suitable to this application is a non-neuromorphic event based camera. Such a camera subtracts consecutive frames pixel by pixel within the sensor itself at high speed in order to achieve a differential. Where such an option is chosen, equation 4 is not necessary to the algorithm.

A pixel belongs to the static background if the following condition is satisfied:

$${max}_{1 \leq m \leq {n}_{f}} [ \tilde{I} ( p , {t}_{m} ) ] - {min}_{1 \leq m \leq {n}_{f}} [ \tilde{I} ( p , {t}_{m} ) ] \leq {δ}_{I} \qquad ( 5 )$$

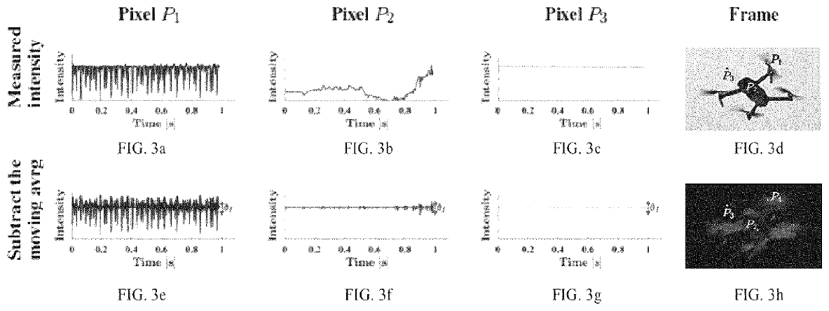

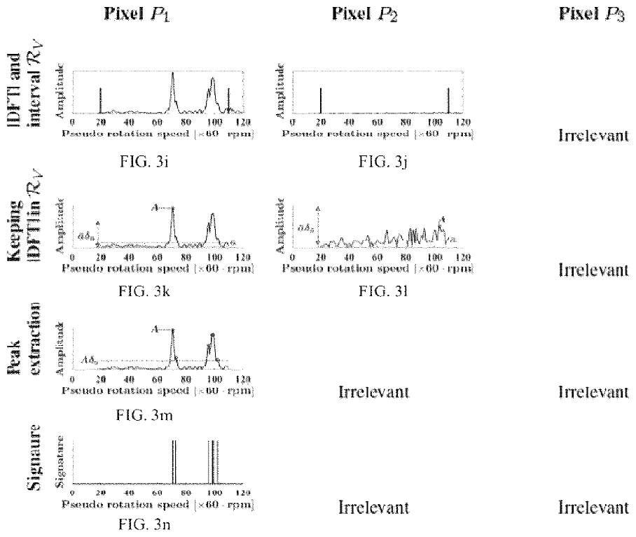

Intensity threshold δl is chosen according to the sky conditions (blue, cloudy, rainy) and defines the minimum contrast expected between the drone and background. We provide an illustrative example with a video (frame rate of 240 Hz) showing a hovering quadcopter (four propellers) having Nb=2 blades per propeller. FIG. 3d shows one frame extracted from a video (four propellers, frame rate 240 Hz, two blades per propeller). Pixel p1 belongs to the area covered by a blade in motion, pixel p2 belongs to a part of the drone other than propellers, and pixel p3 does not belong to the drone. Intensity signals measured at these pixels are presented in FIG. 3a, FIG. 3b and FIG. 3c respectively. Their respective pseudo intensity signals, obtained by subtracting the moving average, are shown in FIG. 3e, FIG. 3f and FIG. 3g respectively. For the chosen intensity threshold δl, pixel p3 is classified as static background pixel. Further processing is irrelevant for pixels which, like pixel p3, belong to the static background.

Static background subtraction is performed by applying a threshold to the difference between the maximum and minimum pixel intensities over the entire video sequence (see FIG. 3h), and not the difference of consecutive frames as traditionally done. Indeed, due to the rotation of the propellers, the pixels covered by the blades can receive background light for several consecutive frames; they can also receive the light reflected by the blades during several consecutive frames. In either case, consecutive frame difference can yield a very small intensity value at these pixels, causing an error in the estimated static background. Taking the difference between the maximum and minimum pixel intensities over the entire video sequence improves the static background estimation.

For peak extraction, Fp is defined as the normalized DFT magnitude of intensity signal {I(p,tₘ)}ₘ₌₁^{m=n}^{_{f}} measured at pixel p (FIG. 3i-j) and R_{\tilde{V}}=[\tilde{V}_{P}^{min}; \tilde{V}_{P}^{max}] as the range of pseudo propeller rotation speed \tilde{V} P (region delimited by the vertical brown lines in FIG. 3i and FIG. 3j). The lower bound of R\tilde{V} is not equal to zero, i.e., \tilde{V} min P>0. The mean amplitude is computed, a⁻ of Fp in interval R\tilde{V} (FIG. 3k and FIG. 3l) and locate all the peaks, actually the local maximums, present in interval R\tilde{V}. A is defined as the amplitude of the highest peak. User-defined coefficient δa⁻≥1 is used to ensure that the highest peak is sufficiently high to be relevant; the intention is to avoid any pixel belonging to parts of the drone other than its propellers, belonging to other flying entities, or belonging to a moving background. Thus, a pixel is kept for the next steps if the amplitude A of its highest peak satisfies the following condition: A≥aδ⁻a⁻(EQ6).

For the example in FIG. 3, only pixel p1 is kept for the next steps (FIG. 3k); pixel p2 does not show a relevant peak although it belongs to the drone (FIG. 3l). For each pixel kept after previous steps, we extract the position of all peaks whose amplitude Apk satisfies the following condition:

$${A}_{pk} \geq A {δ}_{a} \qquad ( 7 )$$

where δa∈]0; 1] is a user-defined coefficient. We finally define Pp as the group of peak positions satisfying (7) at pixel p. FIG. 3m indicates the peaks selected at pixel p1 in the considered example. These peaks form the signature obtained as outlined in FIG. 3n.

Considering the teachings of the previous aspect, for a single propeller, it was shown that the positions of the highest peaks in the DFT magnitude are identical for all pixels covered by the blades, and that this set of peak positions forms the propeller fingerprint. Further it was shown that one of these positions (the position of the highest peak for example) can be used as the quantitative unambiguous propeller fingerprint. For a multicopter, it is very likely that propellers will have different fingerprints since they individually provide different amount of energy to support the motion of the drone. Moreover, there will always be a great similarity between the DFT magnitudes of the pixels covered by the same blades, but, unlike the ideal case in section III, we will notice a drift in the peak positions. This drift is due to the drone body shifting and vibrations caused by the drive of the rotating propellers and the wind. Parameter δ_{d} is used to take this drift into account. Consider the group P={Pₚ}ₚ₌₁^{p=n}^{ₚ} formed by all the peak positions Pp, p=1, 2, . . . , np determined as discussed previously. Define Lₚ as the label of pixel p. Also define Vi, i=1, 2, . . . , nV as the unique set of peak positions defined as follows:

$$\{ \begin{matrix}{𝒱}_{i} ∈ 𝒫 \\ {𝒱}_{i} \neq {𝒱}_{j} , i \neq j\end{matrix} \qquad ( 8 )$$

Algorithm 1 describes the voting consensus used to determine the propellers-induced drone signature, that is, to classify pixels as belonging or not to a region covered by the blades of the drone (see FIG. 3o) by way of the following steps:

### Algorithm 1

(1) Use (EQ8) to extract Vᵢ, i=1, 2, . . . , nV the unique set of peak positions in P.
(2): Use Vᵢ, i=1, 2, . . . , n_{V} as bins to compute the histogram of P.
(3): V is the bin having the highest percentage of occurrences.
(4): Use the drift parameter δ_{d} to define interval Rd=[V−δ_{d}; V+δ_{d}].
(5): Assign the label V (set Lₚ=V) to all pixels not yet labeled (i.e. for which the label is currently Lₚ=0) and for which we can find an element of Pp belonging to Rd.

Algorithm 2 summarizes the steps used to extract the PIDS from high frame rate videos according to the following steps:
(1) Inputs: camera frame rate f_{c}; range of propeller rotation speed R_{\tilde{V}}; intensity threshold δₗ; user-defined coefficients δₐ and δₐ₋, drift parameter δ_{d}; high frame rate video intensities.
(2) Initialize all pixel labels Lₚ, p=1, 2, . . . , nₚₜ to zero.
(3) Peak extraction.
   (a) Take intensity signal of next pixel p and compute pseudo intensity signal (EQ4).
   (b) if (EQ5) is satisfied, set Lₚ=−1 (label for background) and go to step (3a).
   (c) Compute Fₚ, the normalized DFT magnitude of pseudo intensity signal (EQ4).
   (d) Compute the mean amplitude a⁻ of Fₚ in interval R\tilde{V}.
   (e) Extract all peaks in interval R\tilde{V} and find A, the amplitude of the highest peak.
   (f) if A<aδ⁻a⁻, set Lp=−1 (label for background) and go to step (3a).
   (g) Build Pp which contains the positions of the peaks whose amplitude is greater than Aδa and go to step (3a).
(4) Voting consensus.
   (a) Consider P={Pₚ} p=nₚₜ p=1 formed by the peak positions Pp of pixels not yet labeled (i.e. for which the label is currently Lₚ=0).
   (b) if ∃P, Apply Algorithm 1 and go to step (4a).
(5) Output: detected drone. The current video frame is segmented into two groups of pixels: background pixels (Lp=−1) and PIDS (Lp>0).

The primary data used is a video stream obtained using a high speed camera observing the sky from a fixed point. However, the algorithm presented takes as input a high frame rate video capturing a stabilized (motion-compensated) flying entity. This means that the input video of algorithm presented has all frames registered in the same local system coordinate linked to the flying entity. Such a video is built from the primary video stream by tracking the flying entity continuously over time and stacking the frame-by frame tracking results up to the current frame. In the present study, we perform the tracking and the stabilization by utilizing the difference in pixel intensities between consecutive video frames. The resulting event-based approach is straightforward, has a low computation cost and does not require training data. By event, we mean a rapid intensity change at a given pixel. Neuromorphic cameras can monitor this changes within very short periods of time (˜ μs) and thus can capture events (at each pixel) with high temporal resolution. In the proposed approach, events are detected by comparing pixel intensities between consecutive frames in the high frame rate video stream. Thus events are captured with a temporal resolution of 1/f_{c} using a camera with frame rate f_{c}. Event at a given pixel is determined by applying a threshold to the difference between pixel intensities of consecutive frames. Consider two consecutive frames captured with the frame rate fc. The event threshold δ_{E} is defined as the minimum intensity change related to a motion occurring between these consecutive frames. The event E(p, tₘ) at pixel p in the m^{th} frame is determined as follows:

$$\{ \begin{matrix}E ( p , {t}_{m} ) = 1 , & if \vert I ( p , {t}_{m} ) - I ( p , {t}_{m - 1} ) \vert > {δ}_{E} \\ E ( p , {t}_{m} ) = 0 , & otherwise\end{matrix} \qquad ( 9 )$$

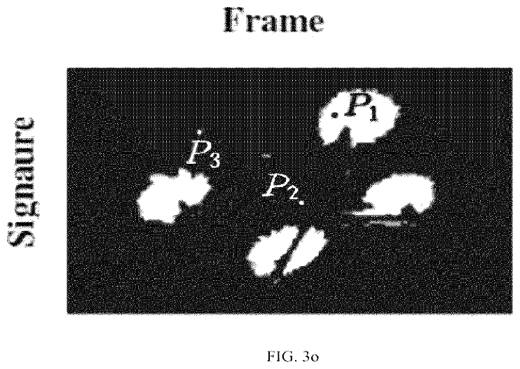

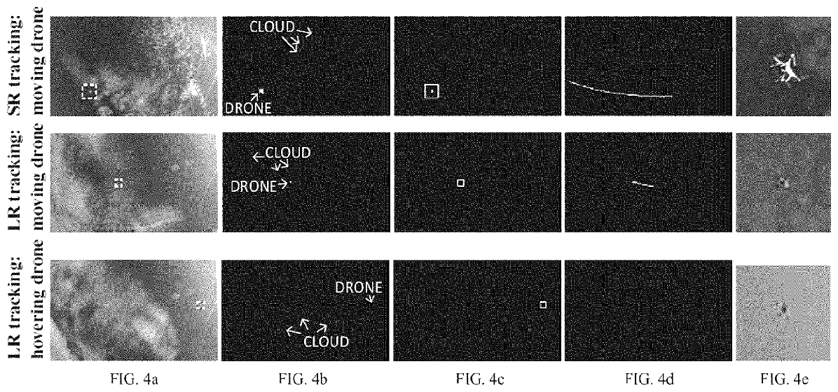

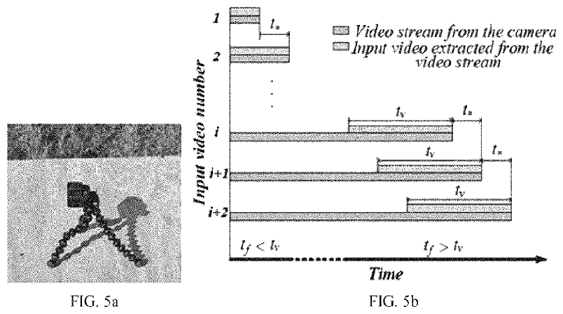

For events related to flying entities with strong kinematic parameters (moving speed, rotation speed), δ_{E} must be sufficiently high to avoid capturing events related to flying entities moving slowly as well as moving backgrounds. The event image corresponding to the m^{th} frame can be viewed as the result of the motion-based segmentation of the corresponding frame. Flying entities can therefore be tracked and their motion can be compensated using only the temporal information at each pixel. Thus, using the high frame rate video it is possible to: (1) capture pixel events occurring between consecutive frames; (2) determine the trajectory of flying entities in the sky by aggregating events related to them in the entire video sequence; (3) perform a continuous tracking of moving entities in the sky; (4) compensate for the motion of these entities by stacking the tracking results. We illustrate the event-based tracking of flying entities in FIG. 4 by considering three scenarios. The first scenario is the short range (SR) tracking where the flying entity is moving close to the camera and is therefore captured with a very good spatial resolution. The second scenario is the long range (LR) tracking where the flying entity moves far away from the camera and is captured with very few pixels (low spatial resolution). In the third scenario the flying entity is hovering far away (long range) from the camera. The current frame (FIG. 4a) is sent to the event detector. FIG. 4b shows the event image obtained using a low threshold δ_{E1}. Events related to the motion of the flying entity are captured as well as event related to the cloud moving very slowly. FIG. 4c is obtained with a threshold δ_{E2}>δ_{E1} and shows only events related to the flying entity. Local clusters are formed among pixels associated with an event and the centroid of each cluster is taken as the position of a flying entity in the current video frame. The trajectory of each flying entity is then obtained throughout the video sequence (FIG. 4d): first, the determined positions of flying entities in the previous frames are considered; second, each position in a frame is matched to at most one position in the previous frame and at most one position in the next frame; Third, the matching is performed so that the deviation between the paired positions in consecutive frames is minimal. The tracking result of a flying entity in a given frame is a region of interest centered at the determined centroid (see the red rectangle in FIG. 4a and FIG. 4c). FIG. 4e shows the tracking result for the frame in FIG. 4a. By stacking these tracking results frame after frame, stabilized video is built to supply as input to the proposed algorithm. Note that, there will be as many stabilized videos as there are detected flying entities (centroids) in the current frame. The PIDS extracted from each video will confirm the corresponding flying entity as being a drone or not. Experimentally, the following setup is suitable for the methodological aspects of the invention: a GoPro Hero 6 black camera mounted on a tripod and observing the sky from a fixed position as outlined in FIG. 5a. According to a demonstration setup, the camera has vertical, horizontal and diagonal field of views of 69.5°, 0.2° and 0.6° respectively. It may be configured to capture RGB videos (8 bits, H265 compression) with a resolution of 1080×1920 and a frame rate of fc=240 Hz.

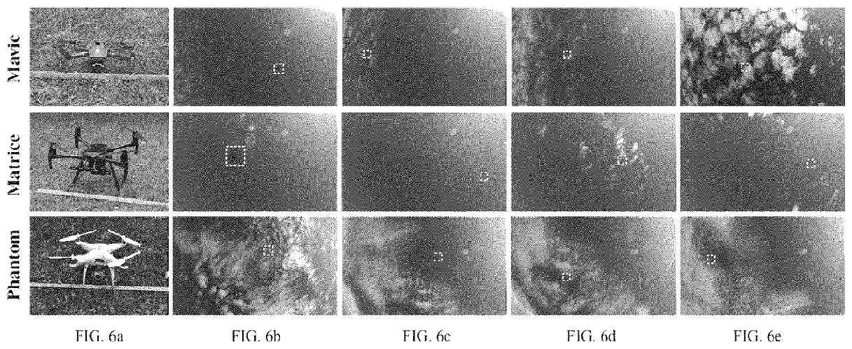

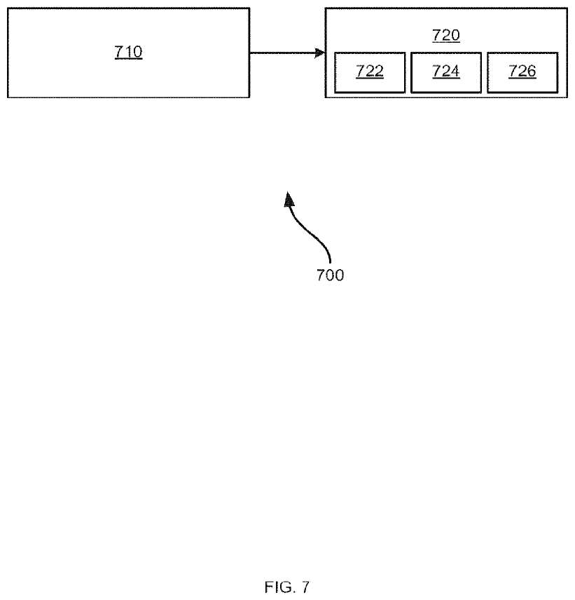

Three drones were tested as suitable targets to collect the data, namely, a Dji Mavic Pro (Mavic), a Dji Matrice (Matrice), and a Dji Phantom 4 Pro V2 (Phantom), all shown in FIG. 6a. A flight scenario involved a drone moving slowly (˜2 m/s) or quickly (˜6 m/s) at a given altitude chosen such that the drone was represented by very few pixels (we will use “low resolution” to refer to this case) or a sufficient number of pixels (we will use “high resolution” to refer to this case) throughout the video sequence. FIG. 6b-e show some recorded video frames which include backgrounds changing from clear sky to scattered clouds.

According to a basic aspect, and with reference to FIG. 7, the invention can be understood as a method of detecting a drone having a propeller with a distinct propellor rotation speed comprising imaging 710 a plurality of images of a scene with a high performance camera, and detecting 720 in said images, for at least one pixel of said camera, a fingerprint characteristic that corresponds to said distinct propeller rotation speed. The step of detecting 720 may include sub-steps of static background subtraction 722, peak detection 724, and voting consensus 726. The fingerprint feature may be a series of integer multiples of a base rotation speed. Peak detection 722 may be performed according to a fitting algorithm. The highest peak of the fingerprint may be used to determine the rotation speed. The method may also compromise a tracking step. The imaging step may be performed by at least one of a high-speed camera and a non-neuromorphic event-based camera. Each of the features mentioned in this aspect may be otherwise understood as described according to the description of same items found herein above in reference to the other aspects.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations may perform routines having blocks, or employ systems having blocks, in a different order, and some processes or blocks may be deleted, moved, added, subdivided, combined, and/or modified to provide alternative or subcombinations. Each of these processes, message/data flows, or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges. Those skilled in the art will also appreciate that the actual implementation of a database may take a variety of forms, and the term “database” is used herein in the generic sense to refer to any data structure that allows data to be stored and accessed, such as tables, linked lists, arrays, etc.

The teachings of the methods and system provided herein can be applied to other systems, not necessarily the system described above. The elements, blocks and acts of the various implementations described above can be combined to provide further implementations.

Any patents and applications and other references noted above, including any that may be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

While certain aspects of the technology are presented below in certain claim forms, the inventors contemplate the various aspects of the technology in any number of claim forms. For example, while only one aspect of the invention is recited as implemented in a computer-readable medium, other aspects may likewise be implemented in a computer-readable medium. Accordingly, the inventors reserve the right to add additional claims after filing the application to pursue such additional claim forms for other aspects of the technology.

1. A method of detecting a drone having a propeller with a distinct propellor rotation speed comprising:
imaging a plurality of images of a scene with a high performance camera,
detecting in said images, for at least one pixel of said camera, a fingerprint characteristic that corresponds to said distinct propeller rotation speed.

2. The method of claim 1 wherein said fingerprint is a series of integer multiples of a base rotation speed.

3. The method of claim 1 wherein said detection is performed by a peak detection fitting algorithm.

4. The method of claim 3 wherein a highest peak of the fingerprint is used in determining the rotation speed.

5. The method of claim 1 further including the step of tracking any motion of said drone across said plurality of images.

6. The method of claim 1 wherein detection comprises static background subtraction.

7. The method of claim 1 wherein detection comprises a voting consensus to reconcile pixels of various propellors and drone body.

8. The method of claim 1 wherein the high-performance camera is a high speed camera

9. The method of claim 1 wherein the high-performance camera is a non-neuromorphic event-based camera.

10. An apparatus for detecting a drone having a propeller with a distinct propellor rotation speed comprising:
a high performance camera for imaging a plurality of images of a scene, and
a detector for detecting in said images, for at least one pixel of said camera, a fingerprint characteristic that corresponds to said distinct propeller rotation speed.

11. The apparatus of claim 10 wherein said detector performs a peak detection fitting algorithm on the images.

12. The apparatus of claim 11 wherein the detector uses a highest peak of the fingerprint in determining the rotation speed.

13. The apparatus of claim 10 wherein the detector further tracks any motion of said drone across said plurality of images.

14. The apparatus of claim 10 wherein the detector performs static background subtraction.

15. The apparatus of claim 10 wherein the detector uses a voting consensus to reconcile pixels of various propellors and drone body.

16. The apparatus of claim 10 wherein the high-performance camera is a high speed camera.

17. The apparatus of claim 10 wherein the high-performance camera is a non-neuromorphic event-based camera.
